(19) United States
(12) Patent Application Publication
(10) Pub. No.: US 2026/0295501 A1
(43) Pub. Date: Oct. 1, 2026

(54) DAC APPARATUS

(71) Applicant: Honda Motor Co., Ltd., Tokyo (JP)

(72) Inventors: Keisuke Shimizu, Saitama (JP); Eijiro Nishimura, Saitama (JP)

(21) Appl. No.: 19/575,777

(22) Filed: Mar. 23, 2026

(30) Foreign Application Priority Data
Mar. 28, 2025 (JP) 2025-055213

(51) Int. Cl. B01D 53/04

(52) U.S. Cl. CPC B01D 53/0446; B01D 2257/504; B01D 2259/40083

(57) ABSTRACT

A DAC apparatus to recover CO₂ in the atmosphere, includes: a plurality of adsorption chambers each provided with an adsorbent for adsorbing or absorbing CO₂; and vacuum piping including individual piping connected with each of the plurality of adsorption chambers, and junction piping connecting the individual piping with a vacuum pump. The individual piping is provided with a pressure drop portion.

### CROSS-REFERENCE TO RELATED APPLICATION

This application is based upon and claims the benefit of priority from Japanese Patent Application No. 2025-055213 filed on Mar. 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, a DAC apparatus that recovers CO₂ in the atmosphere using an adsorbent for adsorbing or absorbing CO₂ is known. For example, in the DAC apparatus of JP 2024-048937 A, after the atmosphere is circulated into an adsorption chamber in which an adsorbent is provided to adsorb CO₂ in the atmosphere to the adsorbent, the inside of the adsorption chamber is depressurized using a vacuum pump to desorb CO₂ from the adsorbent. Thus, a desorption gas having a high CO₂ concentration is recovered. In addition, in the DAC apparatus in EP 3806981 A1, a plurality of adsorption chambers, in each of which an adsorbent is provided, are provided, and adsorption and desorption are simultaneously performed by shifting the timing.

However, in a case where the plurality of adsorption chambers are provided as in the DAC apparatus described in EP 3806981 A1, the desorption gas from each adsorption chamber delays the desorption of CO₂ in another adsorption chamber, and CO₂ recovery efficiency may decrease as the entire apparatus.

### SUMMARY OF THE INVENTION

An aspect of the present invention is a DAC apparatus configured to recover CO₂ in the atmosphere, including: a plurality of adsorption chambers each provided with an adsorbent for adsorbing or absorbing CO₂; and vacuum piping including individual piping connected with each of the plurality of adsorption chambers, and junction piping connecting the individual piping with a vacuum pump. The individual piping is provided with a pressure drop portion.

Another aspect of the present invention is a DAC apparatus configured to recover CO₂ in the atmosphere, including: an adsorption chamber provided with an adsorbent for adsorbing or absorbing CO₂; a plurality of adsorption chamber groups each including a plurality of the adsorption chamber; and vacuum piping including group piping connected with each of the plurality of adsorption chamber groups, and junction piping connecting the group piping with a vacuum pump. The group piping is provided with a pressure drop portion.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a piping configuration of a DAC apparatus including a plurality of reactors;

FIG. 2 is a time chart for describing an overlap operation of the DAC apparatus;

FIG. 3 is a block diagram schematically illustrating an example of a piping configuration of a DAC apparatus according to an embodiment of the present invention;

FIG. 4 is a diagram for describing a pressure of desorption gas in the piping from each reactor to a vacuum pump shown in FIG. 3;

FIG. 5 is a block diagram schematically illustrating another example of the piping configuration of the DAC apparatus according to the embodiment of the present invention; and

FIG. 6 is a diagram for describing group piping shown in FIG. 5.

### DETAILED DESCRIPTION OF THE INVENTION

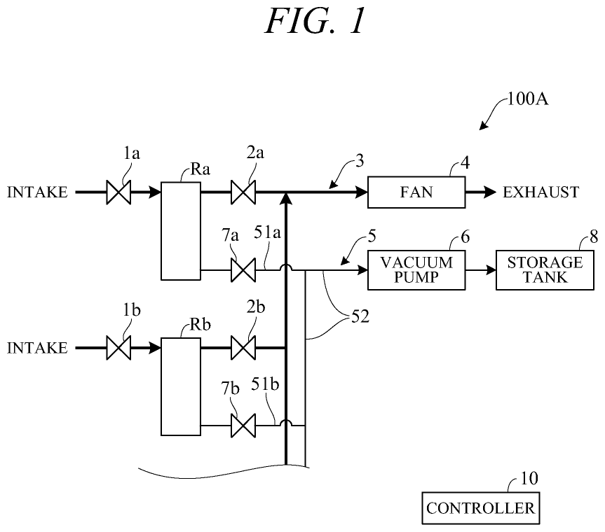

Hereinafter, embodiments of the present invention will be described with reference to FIGS. 1 to 6. FIG. 1 is a block diagram schematically illustrating an example of a piping configuration of a DAC apparatus 100A, which includes a plurality of reactors R (Ra, Rb, and so on). The reactor R includes a housing in which a sealed space (an adsorption chamber) can be formed, and an adsorbent for adsorbing or absorbing CO₂ is provided in the adsorption chamber of the reactor R. As the adsorbent, for example, a solid material composed to adsorb CO₂ at normal temperature and normal pressure and to desorb CO₂ as the temperature rises can be used. For example, an amine-based solid absorbent in which an amine-based compound is carried on an appropriate carrier can be used. The adsorbent is constituted in an appropriate granular shape, is filled in a filter cartridge or the like having a mesh structure, for example, and is accommodated in the adsorption chamber of the reactor R. In the reactor R, a heating device that heats the adsorbent and a cooling device that cools the adsorbent are also provided. For example, a heat exchanger for heating or cooling the adsorbent is provided.

As illustrated in FIG. 1, atmospheric control valves 1 (1a, 1b, and so on) and 2 (2a, 2b, and so on), which open the reactor R to the atmosphere or seal the reactor R from the atmosphere, are provided for the reactor R. The atmospheric control valves 1 and 2 may be provided on piping that connects the adsorption chamber of the reactor R with an external space, or may be provided as a part of a housing (a wall surface) of the reactor R. When the atmospheric control valves 1 and 2 are opened, the adsorption chamber of the reactor R is opened to the atmosphere. When the atmospheric control valves 1 and 2 are closed, the adsorption chamber of the reactor R is sealed. The atmospheric control valve 1 and the atmospheric control valve 2 are provided to face each other with the adsorption chamber interposed between them.

A fan 4 for circulating the atmosphere into the adsorption chamber of the reactor R is connected with the reactor R through appropriate piping (atmospheric piping) 3 and one of the atmospheric control valves 1 and 2 (the atmospheric control valve 2 in the illustrated example). In the illustrated example, when the atmospheric control valves 1 and 2 are open and the fan 4 is driven, the atmosphere is taken into the reactor R through the atmospheric control valve 1, and the atmosphere is exhausted from the reactor R through the atmospheric control valve 2, the atmospheric piping 3, and the fan 4. Thus, when the atmosphere circulates into the reactor R, CO₂ in the atmosphere is adsorbed to the adsorbent in the adsorption chamber (an adsorption step). The atmospheric control valves 1 and 2 and the atmospheric piping 3 are each configured to have a relatively large diameter so as to enable a large amount of atmosphere to circulate into the reactor R. A plurality of atmospheric control valves 1 and a plurality of atmospheric control valves 2 may be provided.

Vacuum piping 5 is further connected with the reactor R. The vacuum piping 5 connects the adsorption chamber of the reactor R with an intake port of the vacuum pump 6. More specifically, the vacuum piping 5 includes: individual piping 51 (51a, 51b, and so on), which communicates with the adsorption chamber of each reactor R; and junction piping 52, which joins the individual piping 51 to communicate with the intake port of the vacuum pump 6. On each piece of the individual piping 51, a vacuum control valve 7 (7a, 7b, and so on), which permits or prohibits the flow of gas in the individual piping 51, is provided. The vacuum control valve 7 may be made up of an on-off valve such as a ball valve, may be made up of an adjustment valve such as a butterfly valve, or may be made up of a combination of them. A storage tank 8 is connected with an exhaust port of the vacuum pump 6 through appropriate piping.

When the atmospheric control valves 1 and 2 are closed, the vacuum control valve 7 is opened, and the vacuum pump 6 is driven, the gas in the adsorption chamber of the reactor R is sucked out by the vacuum pump 6 through the vacuum piping 5. In this situation, the adsorbent in the adsorption chamber is heated by a heat exchanger provided in the reactor R, as necessary, depending on the type of the adsorbent, and thus CO₂ that has been adsorbed to the adsorbent is desorbed. Thus, the pressure in the adsorption chamber of the reactor R becomes lower than that at the time of adsorption, and in addition, the temperature of the adsorbent becomes higher than that at the time of adsorption. CO₂ that has been adsorbed to the adsorbent is desorbed, and the desorption gas mainly containing the desorbed CO₂ is sucked out of the reactor R, is stored in the storage tank 8, and is recovered (a desorption step).

After the adsorption step ends and before the desorption step starts, a deaeration step of deaerating the inside of the adsorption chamber of the reactor R may be performed. When the adsorbent is heated in the desorption step, if the temperature of the adsorbent rises in a state in which oxygen is present in the adsorption chamber, the adsorbent may be subject to oxidation deterioration. Before the desorption step accompanied with the temperature rise of the adsorbent starts, the deaeration step is performed to remove the residual atmosphere containing oxygen in the adsorption chamber. Thus, it becomes possible to prevent the oxidation deterioration of the adsorbent. The deaeration step may be performed using the vacuum piping 5 and the vacuum pump 6. However, a vacuum pump (a vacuum pump for deaeration) different from the vacuum pump 6 is connected with the adsorption chamber of the reactor R through vacuum piping (vacuum piping for deaeration) different from the vacuum piping 5, and then the deaeration step may be performed using such a vacuum pump for deaeration. In this case, it is possible to exhaust the residual atmosphere that has been deaerated from the inside of the adsorption chamber of the reactor R through such a vacuum pump for deaeration without guiding the residual atmosphere to the storage tank 8, so that the concentration of CO₂ recovered into the storage tank 8 can be further increased.

After the desorption step ends and before the adsorption step starts, a cooling step of cooling the adsorbent in the adsorption chamber of the reactor R may be performed. When the atmosphere containing oxygen circulates into the adsorption chamber in a state in which the adsorbent has a high temperature, the adsorbent may be subject to the oxidation deterioration. By performing the cooling step of cooling the adsorbent before the adsorption step of circulating the atmosphere into the adsorption chamber, it becomes possible to prevent the oxidation deterioration of the adsorbent. In the cooling step, processing may wait until the temperature of the adsorbent decreases to fall within a temperature range in which an oxidation reaction does not proceed, but the adsorbent in the adsorption chamber may be cooled by a heat exchanger provided in the reactor R. In this case, the time necessary for the cooling step can be shortened, so that the DAC apparatus 100A can be efficiently operated.

The DAC apparatus 100A includes a controller 10, which controls each unit of the DAC apparatus 100A including the atmospheric control valves 1 and 2, the fan 4, the vacuum pump 6, and the vacuum control valve 7. The controller 10 is made up of a computer including a CPU, a ROM, a RAM, an I/O interface, and other peripheral circuits. The controller 10 controls each unit of the DAC apparatus 100A so that the adsorption step and the desorption step are alternately performed in each reactor R.

More specifically, in a state in which the fan 4 and the vacuum pump 6 are driven, each unit of the DAC apparatus 100A is controlled in such a manner that the atmospheric control valves 1 and 2 are open and the vacuum control valve 7 is closed in the adsorption step, and the atmospheric control valves 1 and 2 are closed and the vacuum control valve 7 is open in the desorption step. Thus, in the adsorption step, the atmosphere circulates into the reactor R and CO₂ in the atmosphere is adsorbed to the adsorbent. In the desorption step, the pressure in the adsorption chamber of the reactor R is reduced and CO₂ is desorbed from the adsorbent.

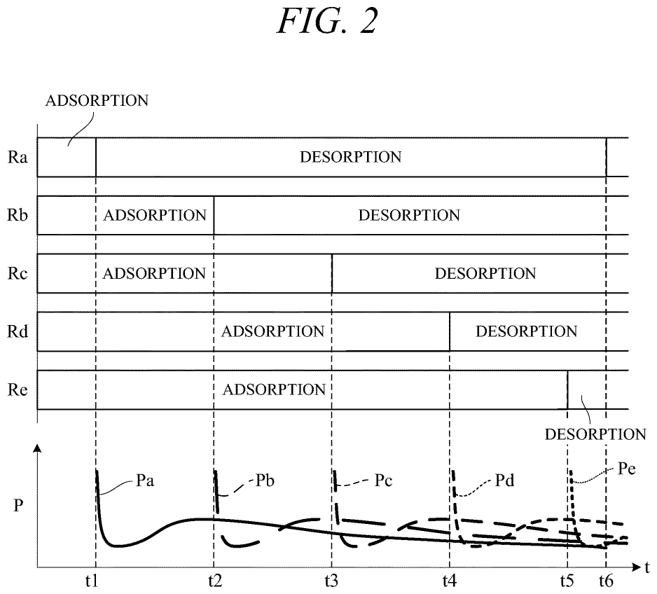

FIG. 2 is a time chart for describing an overlap operation of the DAC apparatus 100A. As illustrated in FIG. 2, in the overlap operation, the adsorption step and the desorption step are sequentially performed in the plurality of reactors R (five reactors Ra to Re in FIG. 2) by shifting the timing. More specifically, each step of each reactor R is performed for a predetermined time, and is started by shifting a predetermined time.

In this case, if the number of reactors R increases, after the desorption step of the earlier reactor Ra starts and before the desorption step ends (that is, while in the desorption step), the desorption step of the next reactor Rb is to start. In other words, the desorption steps of the reactors R may overlap each other. In the example of FIG. 2, in the desorption step of the reactor Ra from time t1 to time t6, the desorption step of the reactor Rb starts at time t2, the desorption step of the reactor Rc starts at time t3, the desorption step of the reactor Rd starts at time t4, and the desorption step of the reactor Re starts at time t5. In other words, the desorption steps of the five reactors Ra to Re overlap each other. Hereinafter, the reactor Ra in which the desorption step is started earlier will be referred to as a preceding desorption reactor, and the reactors Rb to Re in which the desorption steps are started while the desorption step is being performed in the preceding desorption reactor Ra will be referred to succeeding desorption reactors Rb to Re, in some cases.

FIG. 2 also illustrates the pressure P (Pa to Pe) in the adsorption chamber of each reactor R (Ra to Re). As illustrated in FIG. 2, the pressure P of the reactor R is normal pressure (atmospheric pressure) during the adsorption step, and decreases to the final ultimate pressure of the vacuum pump 6 when the desorption step starts. Then, as the temperature of the adsorbent rises, the pressure changes in accordance with the desorption amount of the adsorbate from the adsorbent, and gradually decreases to near the final ultimate pressure of the vacuum pump 6. The pressure P of the reactor R during the desorption step is a negative pressure lower than the atmospheric pressure. As the pressure P in FIG. 2 decreases, the degree of vacuum in the adsorption chamber increases.

In the desorption step, when the temperature of the adsorbent starts to rise, the adsorbates such as CO₂ and water that have been adsorbed to the adsorbent start to be desorbed. In the former half of the desorption step, there are many adsorbates adsorbed to the adsorbent and the desorption amount is large. Therefore, the pressure P of the reactor R is relatively high. In the latter half of the desorption step, the adsorbates adsorbed to the adsorbent decrease and the desorption amount decreases. Therefore, the pressure P of the reactor R decreases.

The adsorption equilibrium in which the adsorption rate at which the adsorbate is adsorbed to the adsorbent is equal to the desorption rate at which the adsorbate is desorbed from the adsorbent shifts toward the desorption side, as the partial pressure of CO₂ in the adsorption chamber decreases. Water desorbed at a temperature lower than that of CO₂ is mostly desorbed in the former half of the desorption step, and thus the CO₂ partial pressure in the adsorption chamber in the latter half of the desorption step is substantially equal to the total pressure (pressure P of the reactor R) in the adsorption chamber.

In a case where the desorption steps of the reactors R overlap each other, the desorption steps of the succeeding desorption reactors Rb to Re respectively start at times t2 to t5, and then the pressure Pb to the pressure Pe of the succeeding desorption reactors Rb to Re exceed the pressure Pa of the preceding desorption reactor Ra in accordance with the desorption amount. In this case, the desorption gas from the succeeding desorption reactors Rb to Re flows into the preceding desorption reactor Ra through the junction piping 52 in FIG. 1. Thus, the pressure Pa of the preceding desorption reactor Ra increases, and the CO₂ partial pressure in the adsorption chamber increases. In this manner, in the reactor R (the preceding desorption reactor Ra) into which the desorption gas has flowed from the other reactors R (the succeeding desorption reactors Rb to Re), the adsorption equilibrium shifts toward the adsorption side, then the desorption of CO₂ is delayed, and the CO₂ recovery efficiency of the entire apparatus decreases.

Therefore, in the present embodiment, the DAC apparatus is configured as follows in such a manner that the influence of the desorption gas from another reactor R is reduced so that the CO₂ desorption in the adsorption chamber of each reactor R can be smoothly performed, and the CO₂ recovery efficiency of the entire apparatus can be improved.

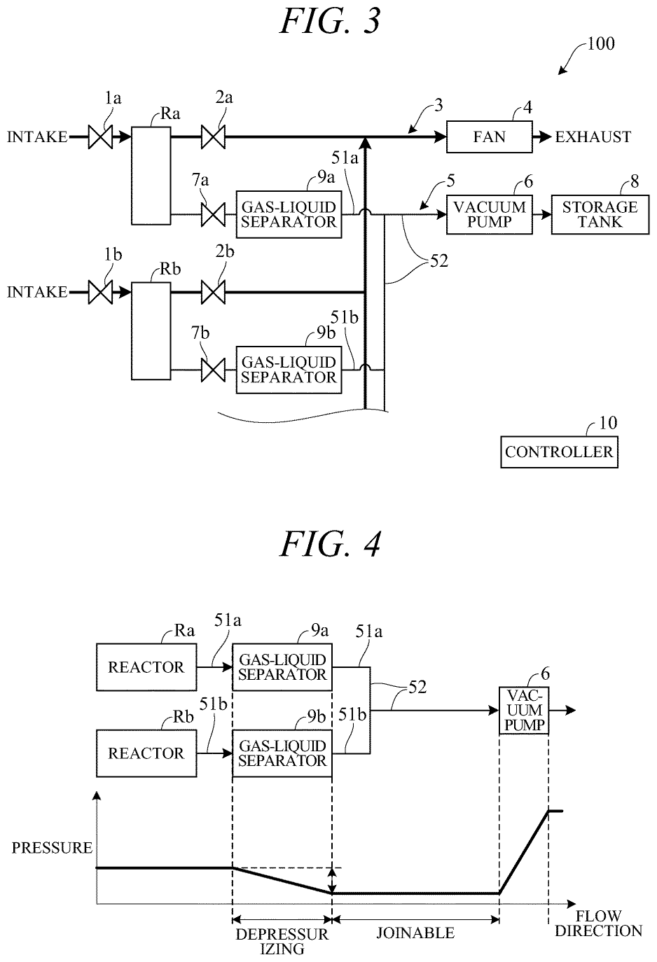

FIG. 3 is a block diagram schematically illustrating an example of a piping configuration of a DAC apparatus 100 according to an embodiment of the present invention. As illustrated in FIG. 3, on each piece of individual piping 51 of the DAC apparatus 100, for example, a gas-liquid separator 9, which removes moisture (water vapor) from the desorption gas flowing through the individual piping 51, is provided as a pressure drop portion that causes a pressure drop equal to or larger than a predetermined value. By providing the pressure drop portion on the individual piping 51 and depressurizing the individual piping 51 and the junction piping 52, which are disposed downstream the pressure drop portion, to be equal to or lower than predetermined pressure (for example, approximately 2000 Pa), it becomes possible to prevent the inflow (pressure interference) of the desorption gas from another reactor R through the junction piping 52. The gas-liquid separator 9 includes, for example, a condenser such as a plate heat exchanger that condenses water vapor in the desorption gas, and a water tank that stores water that has been condensed by the condenser.

By interposing the gas-liquid separator 9 on piping between the reactor R and the storage tank 8, removing moisture from the desorption gas, and then recovering the desorption gas, the concentration of CO₂ recovered in the storage tank 8 can be further increased. In addition, by removing moisture from the desorption gas flowing through the piping from each reactor R to the vacuum pump 6, the efficiency of the vacuum pump 6 can be improved, and each reactor R in the desorption step can be efficiently depressurized. Furthermore, the condensed water that has been separated from the desorption gas can be used as cooling water or the like. When the adsorbent is regenerated or humidity of the adsorbent is adjusted by water vapor, the condensed water can also be used as the water vapor.

FIG. 4 is a diagram for describing the pressure of the desorption gas in the piping from each reactor R to the vacuum pump 6. As illustrated in FIG. 4, the pressure P0 of the desorption gas in the individual piping 51 and the junction piping 52, which are disposed downstream the gas-liquid separator 9, is lower than the pressure P of the desorption gas in the individual piping 51 and the reactor R, which are disposed upstream the gas-liquid separator 9, in accordance with the partial pressure of the water vapor removed by the gas-liquid separator 9. In this case, the desorption gas from the succeeding desorption reactor Rb cannot flow into the preceding desorption reactor Ra, which is disposed upstream the gas-liquid separator 9a, through the junction piping 52, which is disposed downstream the gas-liquid separator 9b. Therefore, the CO₂ desorption in the preceding desorption reactor Ra is smoothly performed.

From the viewpoint of reducing the influence of the desorption gas from another reactor R, the pressure drop portion other than the gas-liquid separator may be provided on the individual piping 51. As the pressure drop portion that causes a pressure drop equal to or larger than a predetermined value, a diameter-reduced portion in which the inner diameter of the individual piping 51 is reduced, a bent portion in which the individual piping 51 is bent, an additional vacuum pump that pressure-feeds the desorption gas, or the like can be provided. In a case where the pressure drop portion other than the gas-liquid separator is provided on the individual piping 51, a gas-liquid separator is provided on the junction piping 52 or piping between the vacuum pump 6 and the storage tank 8, and moisture is removed from the desorption gas, so that the concentration of CO₂ recovered in the storage tank 8 can be increased. In addition, by removing moisture from the desorption gas flowing through the piping from each reactor R to the vacuum pump 6, the efficiency of the vacuum pump 6 can be improved, and each reactor R in the desorption step can be efficiently depressurized.

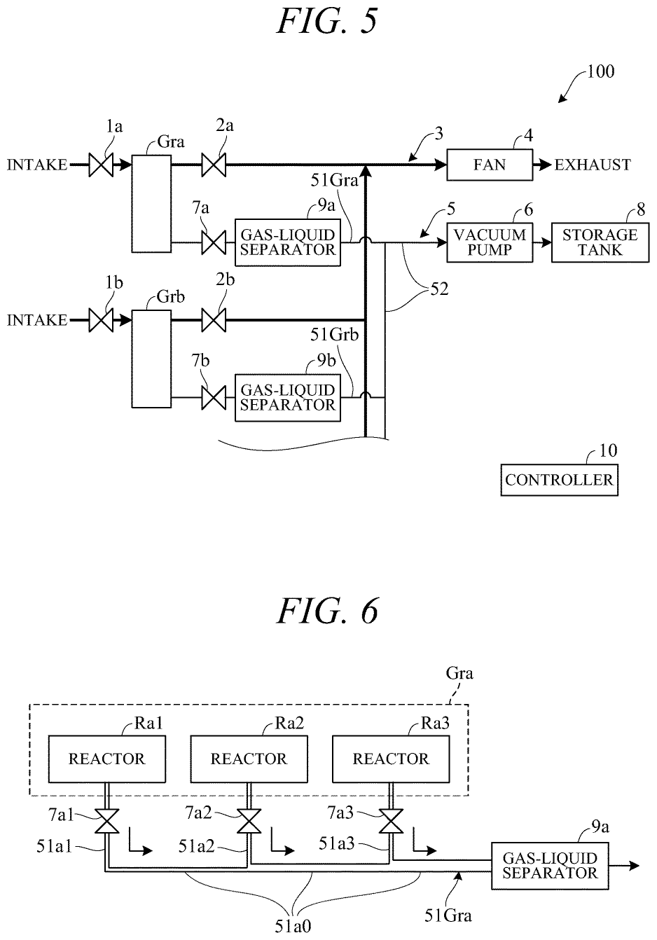

FIGS. 5 and 6 are block diagrams each schematically illustrating another example of the piping configuration of the DAC apparatus 100 according to the embodiment of the present invention. In the examples of FIGS. 5 and 6, the reactors R in which the desorption steps do not overlap each other or the reactors R that are operated on the identical schedule to start and end the desorption step simultaneously are grouped to constitute a reactor group Gr (Gra, Grb, and so on). While the desorption step is being performed in one of the plurality of reactors R constituting each reactor group Gr, the desorption step is not performed in another reactor R, or the desorption steps are simultaneously started in all the reactors R in which the desorption steps are to be simultaneously performed. Originally, there is no difference in the pressure P of the reactors R in the desorption step among the reactors R constituting each reactor group Gr, and there is no influence of the desorption gas from another reactor R.

As illustrated in FIG. 5, the vacuum piping 5 includes: group piping 51Gr (51Gra, 51Grb, and so on), which is connected with each reactor group Gr; and the junction piping 52, which joins the group piping 51Gr to communicate with the intake port of the vacuum pump 6. In the example of FIG. 3, the gas-liquid separator 9 as the pressure drop portion is provided on the individual piping 51 for every reactor R. However, in the examples of FIGS. 5 and 6, the gas-liquid separator 9 is provided on the group piping 51Gr for every reactor group Gr.

The reactors R having no difference in the pressure P out of the reactors R in the desorption step are grouped as the reactor group Gr, the gas-liquid separator 9 as the pressure drop portion is provided on the group piping 51Gr of each reactor group Gr. After the pressure is lowered, the desorption gas of each reactor group Gr is merged together. Thus, it becomes possible to suppress the influence of the desorption gas from another reactor group Gr through the junction piping 52, and to improve the CO₂ recovery efficiency. In this manner, in a case where the reactors R having no difference in the pressure P out of the reactors R in the desorption step are grouped as the reactor group Gr, the installed number of gas-liquid separators 9 as the pressure drop portions can be suppressed.

FIG. 6 is a diagram for describing the group piping 51Gr. In the example of FIG. 6, the reactor group Gra includes three reactors Ra (Ra1, Ra2, and Ra3). The group piping 51Gra includes: individual piping 51a (51a1, 51a2, and 51a3), which communicates with the adsorption chamber of each reactor Ra; and group junction piping 51a0, which joins the individual piping 51a to communicate with an inlet of the gas-liquid separator 9a.

The group junction piping 51a0 is formed in such a manner that the pressure Pa (Pa1, Pa2, and Pa3) of the desorption gas in the individual piping 51a and the reactor Ra is equal to the inlet pressure of the gas-liquid separator 9a. More specifically, the inner diameter of the group junction piping 51a0 is formed to gradually increase in a stepwise manner in accordance with the number of pieces of the individual piping 51a to be joined. For example, the inner diameter is formed to be twice at a position where the individual piping 51 a2 joins the individual piping 51a1, and is formed to be 3/2 times at a position where the individual piping 51a3 joins the individual piping 51a1 and the individual piping 51a2. Thus, the desorption gas from each piece of individual piping 51a is smoothly merged together without a decrease in the flow velocity, and flows through the group junction piping 51a0.

In addition, the group junction piping 51a0 is formed in such a manner that the flow direction of the desorption gas in each piece of individual piping 51a before joining coincides with the flow direction of the desorption gas in the group junction piping 51a0 after joining. In other words, the group junction piping 51a0 is formed in such a manner that the flow direction of the desorption gas flowing into the group junction piping 51a0 from each piece of individual piping 51a coincides with one another. Thus, the flows of the desorption gas from the respective pieces of individual piping 51a are smoothly merged together without being opposite to one another, and the desorption gas flows through the group junction piping 51a0.

According to the embodiments of the present invention, the following operation and effects are achievable.
(1) The DAC apparatus 100 includes: the plurality of reactors R in each of which an adsorbent for adsorbing or absorbing CO₂ is provided; and the vacuum piping 5 including the individual piping 51 connected with each reactor R, and the junction piping 52, which connects a plurality of pieces of the individual piping 51 with the vacuum pump 6 (FIG. 3). The gas-liquid separator 9 is provided on each piece of individual piping 51 (FIG. 3).

By providing the gas-liquid separator 9 as the pressure drop portion on the individual piping 51 of each reactor R, and merging the desorption gas from each reactor R after the pressure is reduced, the influence of the desorption gas from another reactor R through the junction piping 52 can be suppressed, and the CO₂ recovery efficiency can be improved. In addition, by interposing the gas-liquid separator 9 on the piping from the reactor R to the storage tank 8, removing moisture from the desorption gas, and then recovering the desorption gas, the concentration of CO₂ recovered in the storage tank 8 can be further increased. Furthermore, by removing moisture from the desorption gas flowing through the piping from each reactor R to the vacuum pump 6, the efficiency of the vacuum pump 6 can be improved, and each reactor R in the desorption step can be efficiently depressurized.
(2) The DAC apparatus 100 includes: the reactor R in which an adsorbent for adsorbing or absorbing CO₂ is provided; the plurality of reactor groups Gr each including a plurality of reactors R; and the vacuum piping 5, which includes the plurality of pieces of group piping 51Gr connected with each reactor group Gr, and the junction piping 52 for connecting the plurality of pieces of group piping 51Gr with the vacuum pump 6 (FIGS. 5 and 6). On each piece of group piping 51Gr, the gas-liquid separator 9 is provided (FIGS. 5 and 6). By providing the gas-liquid separator 9 as the pressure drop portion on the group piping 51Gr of each reactor group Gr, and merging the desorption gas from each reactor group Gr after the pressure is reduced, it becomes possible to suppress the influence of the desorption gas from another reactor group Gr through the junction piping 52, and to improve the CO₂ recovery efficiency. In addition, the installed number of the gas-liquid separators 9 as the pressure drop portion can be suppressed.
(3) In the plurality of reactors R, the adsorption step and the desorption step are sequentially performed, the adsorption step circulating the atmosphere into the reactor R to adsorb CO₂ in the atmosphere to the adsorbent, the desorption step depressurizing the reactor R using the vacuum pump 6 and then desorbing CO₂ from the adsorbent (FIG. 2). In each reactor group Gr, while the desorption step is being performed in one reactor R of the plurality of reactors R constituting each reactor group Gr, the desorption step is not performed in another reactor R, or the desorption steps are simultaneously started in all the reactors R in which the desorption steps are to be simultaneously performed. Therefore, originally, there is no difference in the pressure P of the reactors R in the desorption step among the reactors R constituting each reactor group Gr, and there is no influence of the desorption gas from another reactor R.
(4) Each piece of group piping 51Gra includes: the individual piping 51a connected with each reactor Ra; and the group junction piping 51a0, which connects the plurality of pieces of individual piping 51a with the gas-liquid separator 9 (FIG. 6). The group junction piping 51a0 is formed in such a manner that the pressure Pa of the plurality of pieces of individual piping 51a is equal to the inlet pressure of the gas-liquid separator 9 (FIG. 6). Thus, it becomes possible to smoothly merge the desorption gas together without reducing the flow velocity of the desorption gas from each piece of the individual piping 51a.

The above embodiment can be combined as desired with one or more of the aforesaid modifications. The modifications can also be combined with one another.

According to the present invention, it becomes possible to improve CO₂ recovery efficiency of the DAC apparatus including a plurality of reactors.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
a plurality of adsorption chambers each provided with an adsorbent for adsorbing or absorbing CO₂; and
vacuum piping including individual piping connected with each of the plurality of adsorption chambers, and junction piping connecting the individual piping with a vacuum pump, wherein
the individual piping is provided with a pressure drop portion.

2. A DAC apparatus configured to recover CO₂ in the atmosphere, comprising:
an adsorption chamber provided with an adsorbent for adsorbing or absorbing CO₂;
a plurality of adsorption chamber groups each including a plurality of the adsorption chambers; and
vacuum piping including group piping connected with each of the plurality of adsorption chamber groups, and junction piping connecting the group piping with a vacuum pump, wherein
the group piping is provided with a pressure drop portion.

3. The DAC apparatus according to claim 2, wherein
in the plurality of adsorption chambers, an adsorption step and a desorption step are sequentially performed, the adsorption step circulating the atmosphere into the adsorption chamber to adsorb CO₂ in the atmosphere to the adsorbent, the desorption step depressurizing the adsorption chamber using the vacuum pump and then desorbing CO₂ from the adsorbent, wherein
in each of the plurality of adsorption chamber groups, while the desorption step is performed in one adsorption chamber of the plurality of adsorption chambers, the desorption step is not performed in another adsorption chamber of the plurality of adsorption chambers, or the desorption step is started simultaneously in all adsorption chambers of the plurality of adsorption chambers in which the desorption step is performed simultaneously.

4. The DAC apparatus according to claim 3, wherein
the group piping includes individual piping connected with each of the plurality of adsorption chambers; and a group junction piping connecting the individual piping with the pressure drop portion, wherein
the group junction piping is formed so that a pressure of the individual piping is equal to an inlet pressure of the pressure drop portion.

5. The DAC apparatus according to claim 1, wherein
the pressure drop portion is a gas-liquid separator.
